(19) United States
(12) Patent Application Publication
(10) Pub. No.: US 2026/0018341 A1
(43) Pub. Date: Jan. 15, 2026

(54) ELECTRONIC COMPONENT

(71) Applicant: Murata Manufacturing Co., Ltd., Nagaokakyo-shi (JP)

(72) Inventor: Yosuke MATSUSHITA, Nagaokakyo-shi (JP)

(73) Assignee: Murata Manufacturing Co., Ltd., Nagaokakyo-shi (JP)

(21) Appl. No.: 19/337,955

(22) Filed: Sep. 24, 2025

Related U.S. Application Data
(63) Continuation of application No. PCT/JP2024/005216, filed on Feb. 15, 2024.

(30) Foreign Application Priority Data
Mar. 28, 2023 (JP) 2023-051277

(51) Int. Cl. H01G 4/252

(52) U.S. Cl. CPC H01G 4/252

(57) ABSTRACT

An electronic component includes a component main body, an external electrode, and a protective member. The component main body has a lower surface of a rectangular shape. The external electrode includes a base layer in contact with the lower surface. The protective member is in contact with the lower surface and the base layer, is along an external edge of the base layer to surround the base layer, and has an inner and outer edges each having a rectangular shape. At least one of a first external edge corner and a first exposed portion corner is beveled. The first external edge cornier is farthest from an intersection point of two diagonal lines of the lower surface, among four external edge corners. The first exposed portion corner is farthest from the intersection point of the two diagonal lines of the lower surface among four exposed portion corners of an exposed portion.

### CROSS-REFERENCE TO RELATED APPLICATIONS

The present application is a continuation of International Application No. PCT/JP2024/005216, filed Feb. 15, 2024, which claims priority to Japanese patent application JP 2023-051277, filed Mar. 28, 2023, the entire contents of each of which being incorporated herein by reference.

### TECHNICAL FIELD

The present disclosure relates to an electronic component.

### BACKGROUND ART

A conventional electronic component, for example, a ceramic electronic component disclosed in Patent Literature 1 is known. In this ceramic electronic component, a coating layer is provided so that at least a part of a peripheral portion of an external terminal electrode provided in a ceramic layer may be covered. Accordingly, the peripheral portion of the external terminal electrode is protected. As a result, the external terminal electrode is significantly reduced from separating from the ceramic layer.

### CITATION LIST

### Patent Literature

[Patent Literature 1] Japanese Patent No. 5708798

### SUMMARY

### Technical Problems

Incidentally, in the field of the ceramic electronic component disclosed in Patent Literature 1, a crack may occur from an end portion of the external terminal electrode in the ceramic layer even when the coating layer is provided.

In view of the foregoing, exemplary embodiments of the present disclosure are directed to provide an electronic component capable of significantly reducing a crack from occurring in a main body, starting from an end portion of an external electrode.

### Solutions to Problems

An electronic component according to an exemplary embodiment of the present disclosure is an electronic component including a component main body, an external electrode, and a protective member, the component main body having a lower surface of a rectangular shape, the external electrode including a base layer, the base layer being in contact with the lower surface, the protective member being in contact with the lower surface and the base layer, being along an external edge of the base layer so as to surround the base layer, and having an inner edge having a rectangular shape and an outer edge having a rectangular shape, a first external edge corner farthest from an intersection point of two diagonal lines of the lower surface, among four external edge corners that the external edge has, being beveled, and/or a first exposed portion corner farthest from the intersection point of the two diagonal lines of the lower surface, among four exposed portion corners that an exposed portion in which the base layer is exposed from the protective member has, being beveled.

### Advantageous Effects

According to the electronic component of the present disclosure, a crack is able to be significantly reduced from occurring in a main body, starting from an end portion of an external electrode.

### BRIEF DESCRIPTION OF DRAWINGS

FIG. 1 is an external perspective view of an electronic component 10.

FIG. 2 is a bottom view of the electronic component 10.

FIG. 3 shows a bottom view and cross-sectional views of the electronic component 10.

FIG. 4 shows a bottom view and cross-sectional views of the electronic component 10.

FIG. 5 is a bottom view of the electronic component 10.

FIG. 6 is a lower side view of an electronic component 10a.

FIG. 7 is a lower side view of an electronic component 10b.

FIG. 8 is a lower side view of an electronic component 10c.

FIG. 9 is a lower side view of an electronic component 10d.

FIG. 10 is a lower side view of an electronic component 10e.

FIG. 11 is a lower side view of an electronic component 10f.

FIG. 12 is a lower side view of an electronic component 10g.

FIG. 13 is a cross-sectional view of an electronic component 10h.

FIG. 14 is a lower side view of an electronic component 10i.

### DESCRIPTION OF EXEMPLARY EMBODIMENTS

### Exemplary Embodiment

### [Structure of Electronic Component 10]

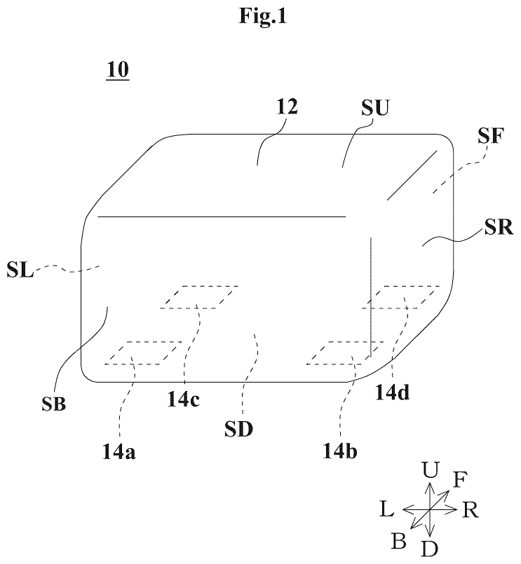

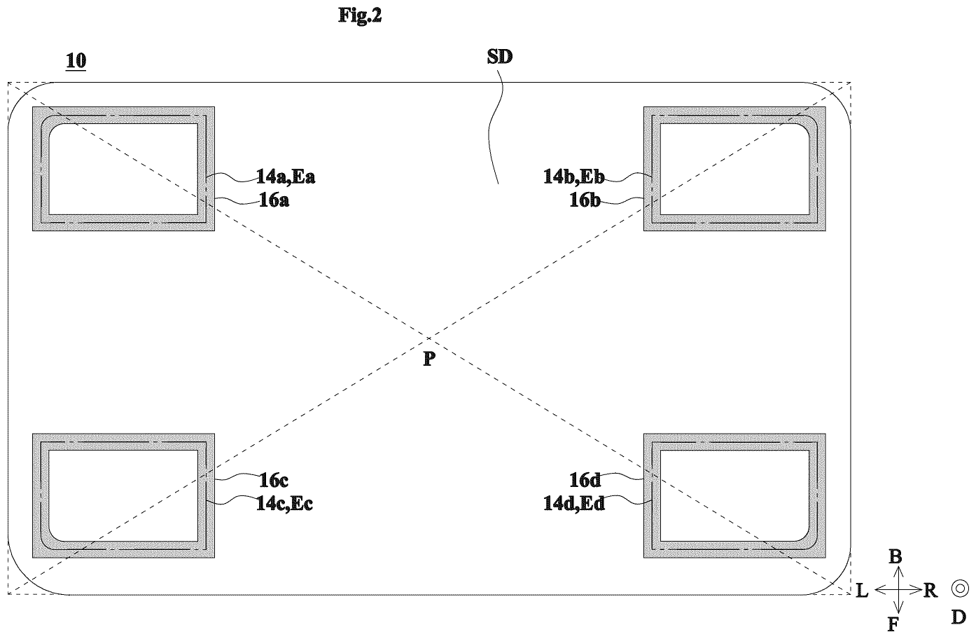

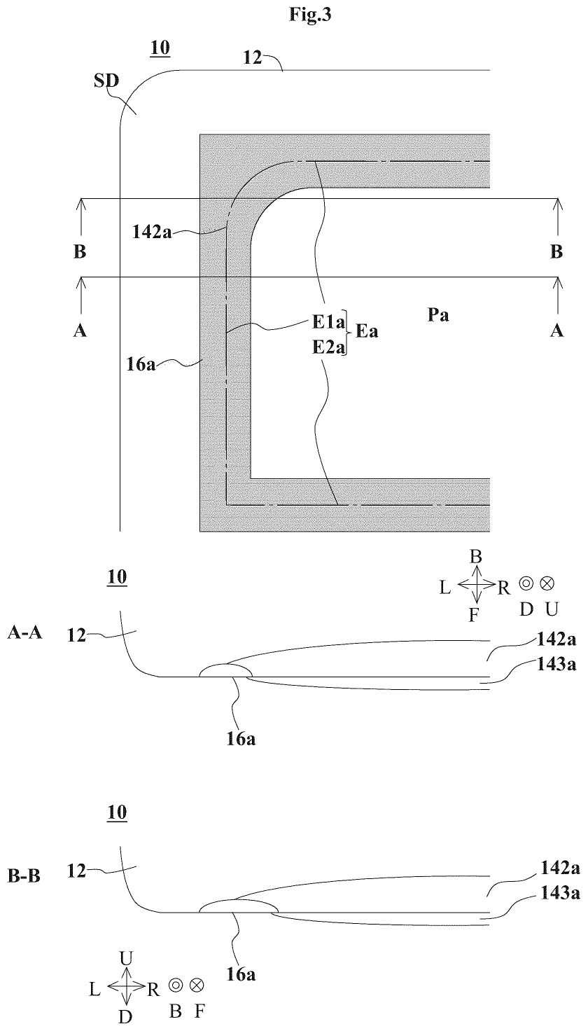

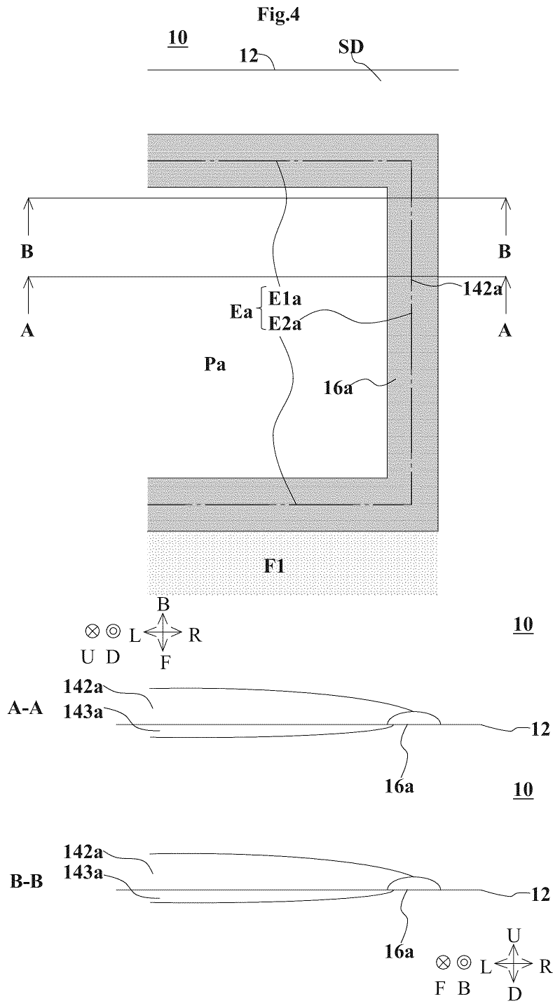

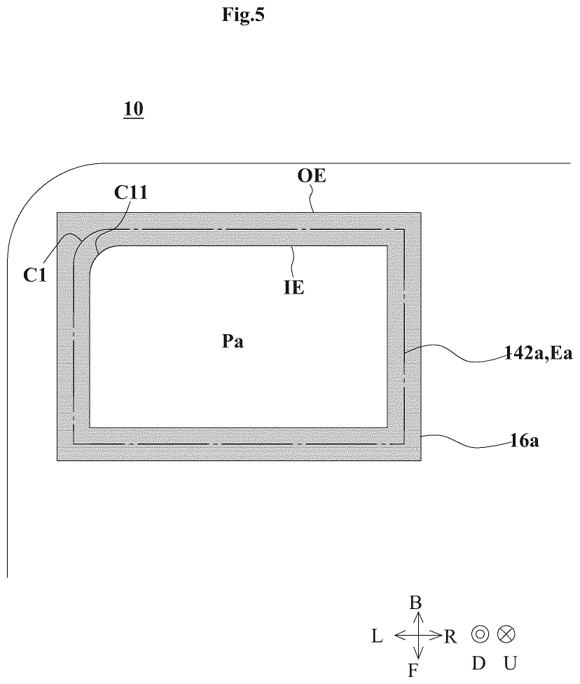

Hereinafter, a structure of an electronic component 10 according to exemplary embodiments of the present disclosure will be described with reference to drawings. FIG. 1 is an external perspective view of the electronic component 10. FIG. 2 and FIG. 5 are bottom views of the electronic component 10. FIG. 3 and FIG. 4 show bottom views and cross-sectional views of the electronic component 10.

In the present specification, directions are defined as follows. A direction in which a plurality of insulator layers are stacked is defined as an up-down direction. The directions orthogonal to the up-down direction are defined as a left-right direction and a front-back direction. The left-right direction and the front-back direction are orthogonal to each other. It is to be noted that the up-down direction, the front-back direction, and the left-right direction in the present exemplary embodiment may not match the up-down direction, the front-back direction, and the left-right direction during the use of the electronic component 10.

First, the structure of the electronic component 10 will be described with reference to FIG. 1 and FIG. 2. The electronic component 10 is, for example, used for a wireless communication terminal such as a smartphone. As shown in FIG. 1, the electronic component 10 includes a component main body 12, external electrodes 14a-14d, and protective members 16a-16d.

The component main body 12 has a structure in which a plurality of insulator layers are stacked in the up-down direction. The component main body 12 has a rectangular parallelepiped shape. The component main body 12, as shown in FIG. 1, has an upper surface SU, a lower surface SD, a left surface SL, a right surface SR, a front surface SF, and a back surface SB. The upper surface SU, the lower surface SD, the left surface SL, the right surface SR, the front surface SF, and the back surface SB have a rectangular shape. The upper surface SU is oriented in the up direction. The lower surface SD is oriented in the down direction. The left surface SL, the right surface SR, the front surface SF, and the back surface SB are side surfaces located between the lower surface SD and the upper surface SU. In addition, each edge of the component main body 12 is beveled. A material of the component main body 12 described above is ceramic.

The external electrodes 14a-14d are provided on the lower surface SD. The external electrode 14a is located near a left back corner of the lower surface SD. The external electrode 14b is located near a right back corner of the lower surface SD. The external electrode 14c is located near a left front corner of the lower surface SD. The external electrode 14d is located near a right front corner of the lower surface SD. The external electrodes 14a-14d, when viewed in the up direction, have a rectangular shape.

Hereinafter, a structure of the external electrode 14a will be described with reference to FIG. 3 to FIG. 5. The external electrode 14a includes a base layer 142a and a plating layer 143a. The base layer 142a is in contact with the lower surface SD. The base layer 142a, when viewed in the up direction, has an external edge Ea having a rectangular shape. When viewed in the up direction, the external edge Ea of the base layer 142a includes a facing portion Ela that faces an external edge of the lower surface SD and a non-facing portion E2a that does not face the external edge of the lower surface SD. The facing portion Ela and the external edge of the lower surface SD face each other, which means that other electrodes are not present between the facing portion Ela and the external edge of the lower surface SD. In other words, the facing portion Ela is an outward-facing portion of the external edge Ea, positioned adjacent to an external edge of the lower surface SD without any other electrodes situated therebetween. In the present exemplary embodiment, the facing portion Ela is the left side and the back side of the base layer 142a. The non-facing portion E2a is the right side and the front side of the base layer 142a. The plating layer 143a will be described later.

The protective member 16a is in contact with the lower surface SD and the base layer 142a and is along the external edge of the base layer 142a so as to surround the base layer 142a. In the present exemplary embodiment, when viewed in the up direction, the entirety of the external edge Ea of the base layer 142a overlaps with the protective member 16a.

In addition, the protective member 16a has a rectangular ring shape. The protective member 16a has an inner edge IE having a rectangular shape and an outer edge OE having a rectangular shape. As shown in FIG. 2 and FIG. 5, a first external edge corner farthest from an intersection point P of two diagonal lines of the lower surface, among four external edge corners that the external edge Ea has, is beveled. The first external edge corner C1 is a left back corner of the external edge Ea. In the present exemplary embodiment, the first external edge corner C1 is rounded. However, three external edge corners except the first external edge corner C1 among the four external edge corners are not beveled.

In addition, as shown in FIG. 2 and FIG. 5, a first exposed portion corner C11 farthest from the intersection point P of the two diagonal lines of the lower surface SD, among four exposed portion corners that an exposed portion Pa in which the base layer 142a is exposed from the protective member 16a has, is beveled. The first exposed portion corner C11 is a left back corner of the exposed portion Pa. In the present exemplary embodiment, the first exposed portion corner C11 is rounded. However, three exposed portion corners except the first exposed portion corner C11 among the four exposed portion corners are not beveled. A material of the protective members 16a-16d described above is ceramic. The material of the protective members 16a-16d is the same as the material of the component main body 12.

As shown in FIG. 3 and FIG. 4, the plating layer 143a is located below the base layer 142a and is in contact with the base layer 142a. The plating layer 143a includes a Ni layer and a Sn layer. The Ni layer contacts the base layer 142a. The Ni layer covers the base layer 142a. The Sn layer contacts the Ni layer. The Sn layer covers the Ni layer. However, an external edge of the plating layer 143a does not contact the base layer 142a but contacts the protective member 16a. Therefore, the external edge of the plating layer 143a is located below the protective member 16a. Thus, plating layer 143a covers the exposed underside of the base layer 142a and extends outwards so that its external edge is located underneath and in contact with the protective member 16a. This design ensures that the edge of the plating layer does not directly touch the edge of the base layer, which helps prevent delamination and cracking.

It is to be noted that, since the structure of the external electrodes 14b-14d and the protective members 16b-16d is the same as the structure of the external electrode 14a and the protective member 16a, the description is omitted.

The electronic component 10 described above is mounted on a circuit board by solder. The solder is applied to the external electrodes 14a-14d. Then, the external electrodes 14a-14d are fixed to external electrodes of the circuit board by the solder.

### Advantageous Effects

According to the electronic component 10, occurrence f a crack in the component main body 12 may be significantly reduced, starting from an end portion of the external electrode 14a. More specifically, when the electronic component 10 is mounted on the circuit board, the external electrodes 14a-14d are fixed to mounting electrodes of the circuit board by the solder. At this time, the external electrodes 14a-14d are subject to force toward the intersection point P of the two diagonal lines of the lower surface SD. In this case, stress easily concentrates on the first external edge corner C1 farthest from the intersection point P of the two diagonal lines of the lower surface, among the four external edge corners that the external edge Ea has. Then, in the electronic component 10, the first external edge corner C1 is beveled. According to this, the stress is significantly reduced from concentrating on the first external edge corner C1 and a crack is able to be significantly reduced from occurring in the component main body 12, starting from the end portion of the external electrode 14a.

In addition, stress easily concentrates on the first exposed portion corner C11 farthest from the intersection point P of the two diagonal lines of the lower surface, among the four exposed portion corners that the exposed portion Pa has. Then, in the electronic component 10, the first exposed portion corner C11 farthest from the intersection point P of the two diagonal lines of the lower surface SD, among the four exposed portion corners that the exposed portion Pa in which the base layer 142a is exposed from the protective member 16a has, is beveled. According to this, the stress is significantly reduced from concentrating on the first exposed portion corner C11 and a crack is able to be significantly reduced from occurring in the component main body 12, starting from the end portion of the external electrode 14a.

### (Modification)

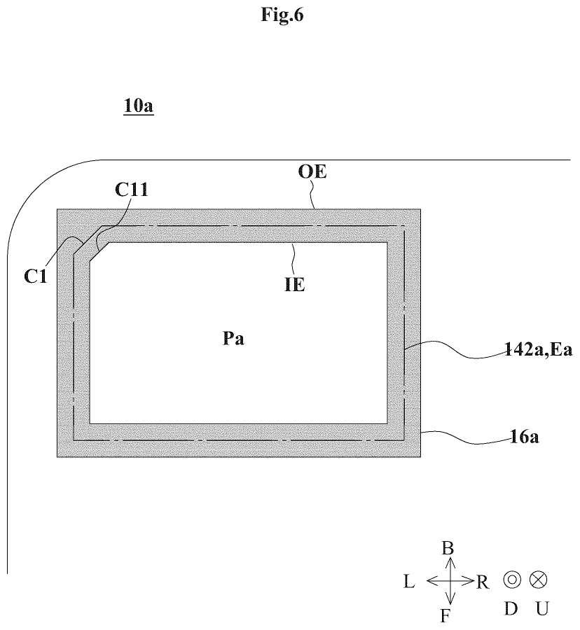

Hereinafter, electronic components 10a-10g according to a modification of the present disclosure will be described with reference to drawings. disclosure of FIG. 6 to FIG. 12 is a lower side view of the electronic components 10a-10g.

As shown in FIG. 6, in the electronic component 10a, the first external edge corner C1 and the first exposed portion corner C11 are chamfered.

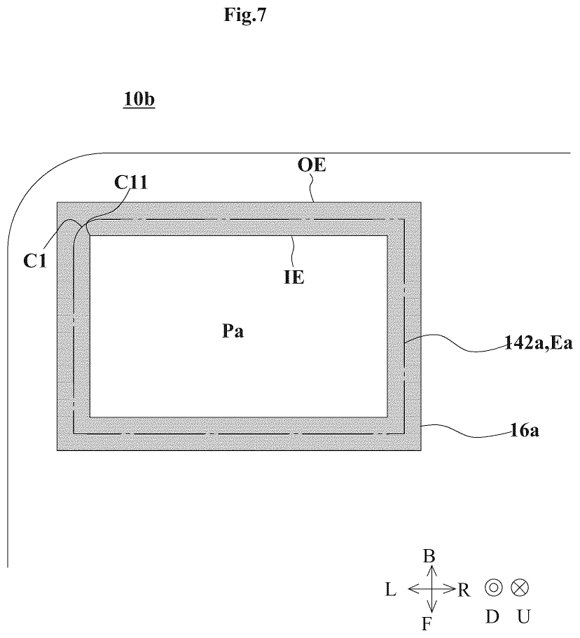

As shown in FIG. 7, in the electronic component 10b, the first external edge corner C1 is rounded. The first exposed portion corner C11 is not beveled.

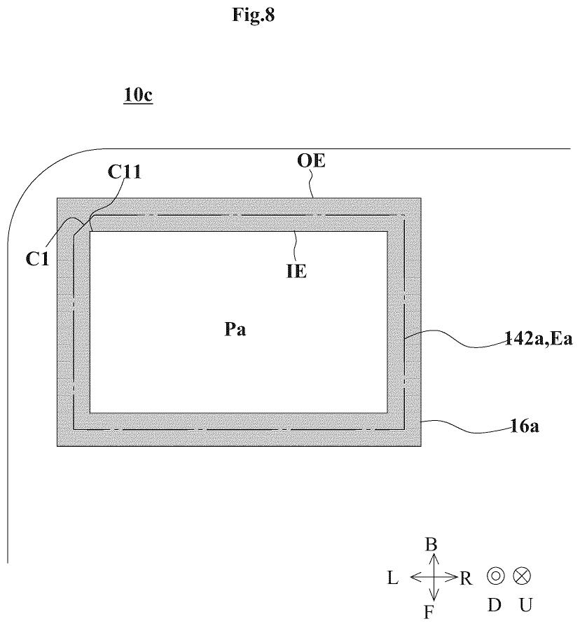

As shown in FIG. 8, in the electronic component 10c, the first external edge corner C1 is chamfered. The first exposed portion corner C11 is not beveled.

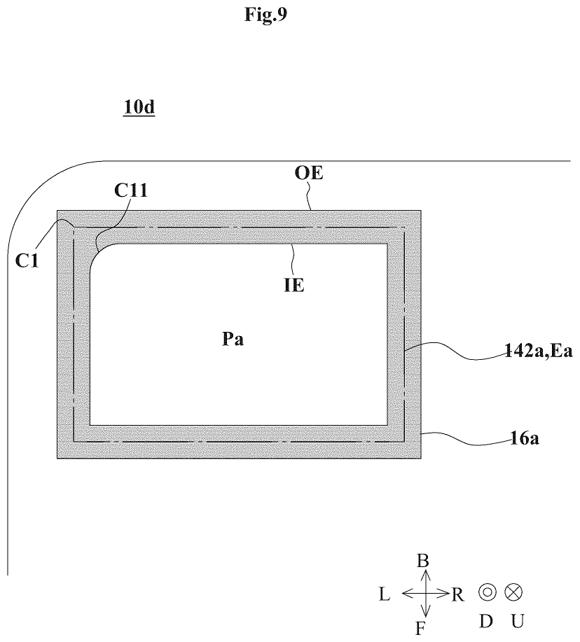

As shown in FIG. 9, in the electronic component 10d, the first external edge corner C1 is not beveled. The first exposed portion corner C11 is rounded.

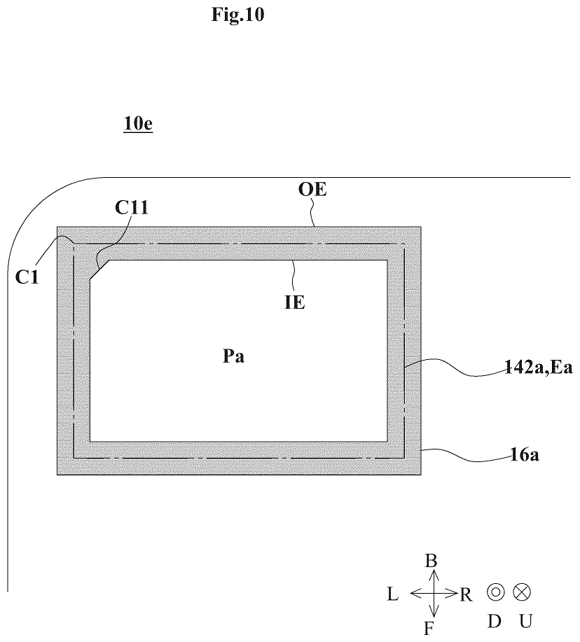

As shown in FIG. 10, in the electronic component 10e, the first external edge corner C1 is not beveled. The first exposed portion corner C11 is chamfered.

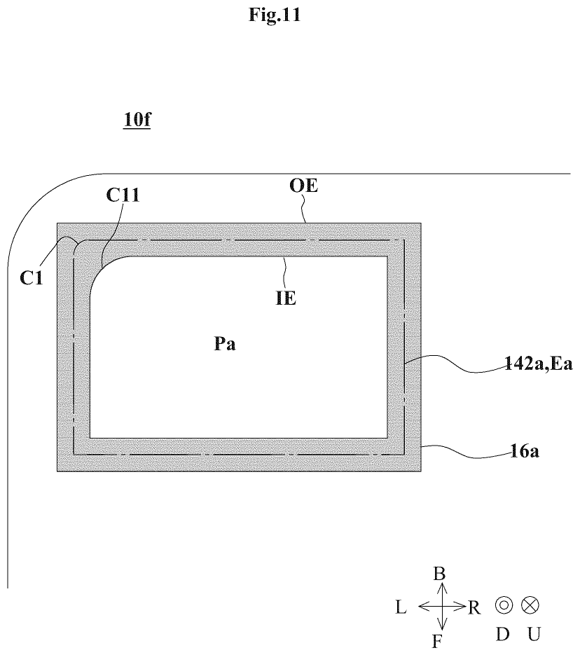

As shown in FIG. 11, in the electronic component 10f, the first external edge corner C1 is rounded. The first exposed portion corner C11 is rounded. However, a distance between the first external edge corner C1 and the first exposed portion corner C11 is larger than a distance between the external edge Ea of the base layer 142a, and an external edge of the exposed portion Pa. According to this, the stress is significantly reduced from concentrating on the first exposed portion corner C11 and a crack is able to be significantly reduced from occurring in the protective member 16a.

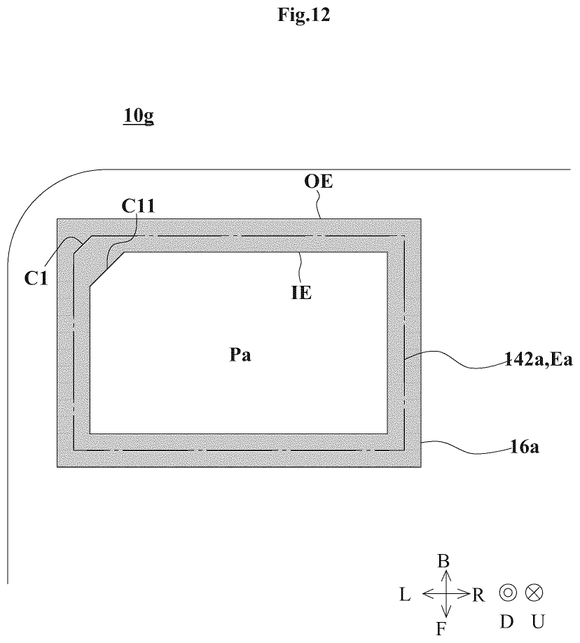

As shown in FIG. 12, in the electronic component 10g, the first external edge corner C1 is chamfered. The first exposed portion corner C11 is chamfered. However, the distance between the first external edge corner C1 and the first exposed portion corner C11 is larger than the distance between the external edge Ea of the base layer 142a, and the external edge of the exposed portion Pa. According to this, the stress is significantly reduced from concentrating on the first exposed portion corner C11 and a crack is able to be significantly reduced from occurring in the protective member 16a.

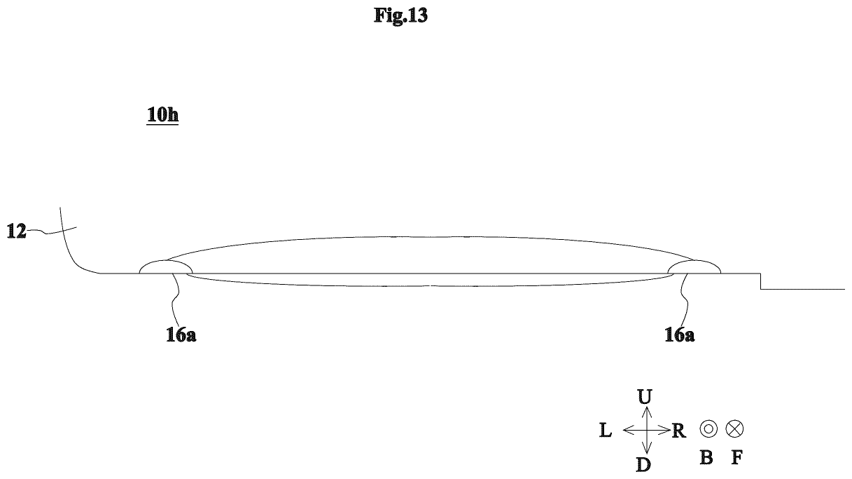

In addition, FIG. 13 is a cross-sectional view of an electronic component 10h. As shown in FIG. 13, an area around the external electrode 14a may be recessed.

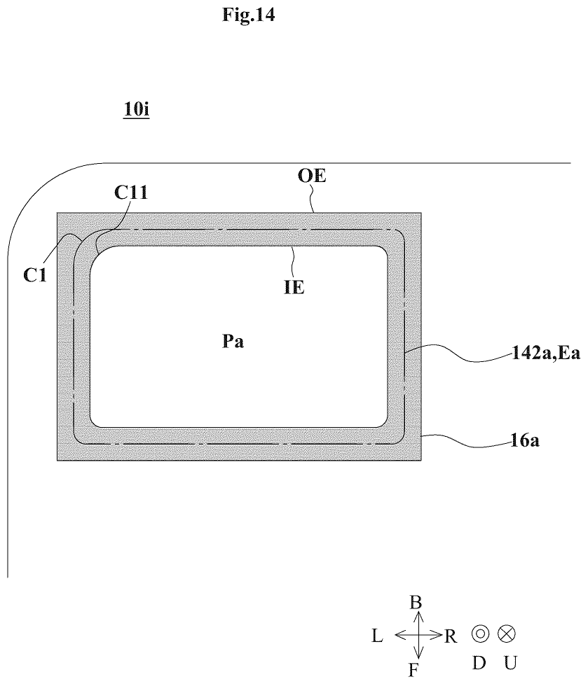

In addition, FIG. 14 is a lower side view of an electronic component 10i. As shown in FIG. 14, in the electronic component 10i, the four external edge corners that the external edge Ea has are rounded. The first external edge corner C1 has the largest beveling amount among the four external edge corners that the external edge Ea has. In addition, in the electronic component 10i, the four exposed portion corners that the exposed portion Pa has are rounded. The first exposed portion corner C11 has the largest beveling amount among the four exposed portion corners that the exposed portion Pa has.

### Other Exemplary Embodiments

The electronic components according to the present disclosure are not limited to the electronic components 10 and 10a-10i, and various changes and modifications may be possible within the scope of the present disclosure. In addition, the structures of the electronic components 10 and 10a-10i may be optionally combined.

It is to be noted that an Au layer may be provided instead of the Ni layer.

It is to be noted that a lower end of the protective member 16a may be located above a first flat-shaped portion F1.

The material of the protective members 16a-16d may not be ceramic.

The material of the component main body 12 may not be ceramic.

The material of the protective members 16a-16d may be different from the material of the component main body 12.

It is to be noted that the protective member 16a, when viewed in the up direction, may not have a ring shape.

It is to be noted that the external electrode 14a, when viewed in the up direction, may have a shape other than a rectangular shape. It is to be noted that the rectangular shape includes a square. The shape other than a rectangular shape is, for example, a circular shape or an elliptical shape.

It is to be noted that the same type of beveling, especially rounding or chamfering, may be applied to at least two external edge corners among the four external edge corners that the external edge Ea has, and the first external edge corner C1 may have the largest beveling amount among the external edge corners that the external edge Ea has and that are beveled. In such a case, the external edge corners except the first external edge corner C1 among the external edge corners that are beveled may have the same beveling amount as each other or may have a different beveling amount from each other. In addition, the four exposed portion corners that the exposed portion Pa has may be beveled in any manner or may not be beveled.

The same type of beveling, especially rounding or chamfering, may be applied to at least two exposed portion corners among the four exposed portion corners that the exposed portion Pa has, and the first exposed portion corner C11 may have the largest beveling amount among the exposed portion corners that the exposed portion Pa has and that are beveled. In such a case, the exposed portion corners except the first exposed portion corner C11 among the exposed portion corners that are beveled may have the same beveling amount as each other or may have a different beveling amount from each other. In addition, the four external edge corners that the external edge Ea has may be beveled in any manner or may not be beveled.

The present disclosure includes the following structure.

(1)

An electronic component in which the electronic component includes a component main body, an external electrode, and a protective member, the component main body has a lower surface of a rectangular shape, the external electrode includes a base layer, the base layer is in contact with the lower surface, the protective member is in contact with the lower surface and the base layer, is along an external edge of the base layer so as to surround the base layer, and has an inner edge having a rectangular shape and an outer edge having a rectangular shape, and a first external edge corner farthest from an intersection point of two diagonal lines of the lower surface, among four external edge corners that the external edge has, is beveled, and/or a first exposed portion corner farthest from the intersection point of the two diagonal lines of the lower surface, among four exposed portion corners that an exposed portion in which the base layer is exposed from the protective member has, is beveled.

(2)

The electronic component according to (1) in which three external edge corners except the first external edge corner among the four external edge corners are not beveled.

(3)

The electronic component according to (1) or (2) in which three exposed portion corners except the first exposed portion corner among the four exposed portion corners are not beveled.

(4)

The electronic component according to any of (1) to (3) in which the first external edge corner farthest from the intersection point of the two diagonal lines of the lower surface, among the four external edge corners that the external edge has, is beveled, the first exposed portion corner farthest from the intersection point of the two diagonal lines of the lower surface, among the four exposed portion corners that the exposed portion in which the base layer is exposed from the protective member has, is beveled, and a distance between the first external edge corner and the first exposed portion corner is larger than a distance between the external edge of the base layer and an external edge of the exposed portion.

### REFERENCE SIGNS LIST

10, 10a-10i: electronic component
12: component main body
14a-14d: external electrode
16a-16d: protective member
142a: base layer
143a: plating layer
C1: first external edge corner
C11: first exposed portion corner
E1a: facing portion
E2a: non-facing portion
Ea: external edge
SB: back surface
SD: lower surface
SF: front surface
SL: left surface
SR: right surface
SU: upper surface

1. An electronic component comprising:
a component main body with a lower surface of a rectangular shape;
an external electrode including a base layer in contact with the lower surface, the base layer having an external edge with four external edge corners; and
a protective member, wherein:
the protective member is in contact with the lower surface and the base layer, the protective member is disposed along the external edge of the base layer so as to surround the base layer, and has an inner edge having a rectangular shape and an outer edge having a rectangular shape; and
at least one of a first external edge corner or a first exposed portion corner is beveled, the first external edge corner being farthest from an intersection point of two diagonal lines of the lower surface, among the four external edge corners, and the first exposed portion corner being farthest from the intersection point of the two diagonal lines of the lower surface, among four exposed portion corners that an exposed portion in which the base layer is exposed from the protective member has.

2. The electronic component according to claim 1, wherein three external edge corners other than the first external edge corner among the four external edge corners are not beveled.

3. The electronic component according to claim 2, wherein three exposed portion corners other than the first exposed portion corner among the four exposed portion corners are not beveled.

4. The electronic component according to claim 3, wherein:
the first external edge corner is beveled;
the first exposed portion corner is beveled; and
a distance between the first external edge corner and the first exposed portion corner is larger than a distance between the external edge of the base layer and an external edge of the exposed portion.

5. The electronic component according to claim 1, wherein:
at least two external edge corners among the four external edge corners that the external edge has are beveled, and the first external edge corner has a largest beveling amount among the external edge corners that the external edge has and that are beveled; and/or
at least two exposed portion corners among the four exposed portion corners that the exposed portion has are beveled, and the first exposed portion corner has the largest beveling amount among the exposed portion corners that the exposed portion has and that are beveled.

6. The electronic component according to claim 5, wherein at least two of the four external edge corners are beveled, and the first external edge corner has a largest beveling amount among the beveled external edge corner.

7. The electronic component according to claim 6, wherein all of the four external edge corners are beveled.

8. The electronic component according to claim 1, wherein three exposed portion corners other than the first exposed portion corner among the four exposed portion corners are not beveled.

9. The electronic component according to claim 1, wherein:
the first external edge corner is beveled;
the first exposed portion corner is beveled; and
a distance between the first external edge corner and the first exposed portion corner is larger than a distance between the external edge of the base layer and an external edge of the exposed portion.

10. The electronic component according to claim 1, wherein the at least one of the first external edge corner or the first exposed portion corner is rounded.

11. The electronic component according to claim 1, wherein the at least one of the first external edge corner or the first exposed portion corner is chamfered.

12. The electronic component according to claim 1, further comprising a plurality of external electrodes, wherein for each external electrode, a respective first external edge corner farthest from the intersection point is beveled.

13. The electronic component according to claim 1, wherein the external electrode further includes a plating layer disposed on the exposed portion of the base layer.

14. The electronic component according to claim 13, wherein an external edge of the plating layer is in contact with the protective member.

15. The electronic component according to claim 1, wherein the protective member has a rectangular ring shape.

16. The electronic component according to claim 1, wherein the material of the protective member is the same as the material of the component main body.

17. The electronic component according to claim 1, wherein only the first external edge corner is beveled.

18. The electronic component according to claim 1, wherein only the first exposed portion corner is beveled.
